(19) United States
(12) Patent Application Publication
(10) Pub. No.: US 2022/0165058 A1
(43) Pub. Date: May 26, 2022

(54) INFORMATION PROCESSING DEVICE, INFORMATION PROCESSING METHOD, TRAINED MODEL GENERATION METHOD, SYSTEM, AND LEARNING DATA SET

(71) Applicant: KOMATSU LTD., Minato-ku, Tokyo (JP)

(72) Inventors: Hironori TODA, Minato-ku, Tokyo (JP); Takashi HORI, Minato-ku, Tokyo (JP)

(73) Assignee: KOMATSU LTD., Minato-ku, Tokyo (JP)

(21) Appl. No.: 17/600,197

(22) PCT Filed: Mar. 26, 2020
(86) PCT No.: PCT/JP2020/013509

§ 371 Date: Sep. 30, 2021

(30) Foreign Application Priority Data
Apr. 9, 2019 (JP) 2019-074297

(51) Int. Cl. G06V 20/13; G06T 7/70; G06V 20/10

(52) U.S. Cl. CPC G06V 20/13; G06T 2207/20081; G06V 20/176; G06T 7/70

(57) ABSTRACT

An information processing device includes: a computing device; a storage device having a trained model stored therein, the trained model being configured to estimate, from image data, a work type of a work performed at a work site where a work machine is operating, the image data being obtained by capturing an image of the work site from the sky; and an output device. The computing device estimates the work type from the image data input thereto, by using the trained model. The computing device causes the output device to output the estimated work type.

### TECHNICAL FIELD

The present disclosure relates to an information processing device, an information processing method, a trained model generation method, a system, and a learning data set.

### BACKGROUND ART

As described in Japanese Patent Laying-Open No. 7-230597 (PTL 1), there has been conventionally known an operation management system for grasping an operation condition of a work machine at a remote location. In the operation management system, the work machine moved within a work site and a reference point within the work site receive a radio wave from a GPS satellite in the sky. Based on the received radio wave, the work machine calculates a three-dimensional position coordinate of the work machine. A personal computer in a construction office that is distant from the work site generates a three-dimensional image indicating a position of the work machine in the work site, based on the three-dimensional position coordinate calculated by the work machine and three-dimensional topography data of the site stored in the personal computer. Furthermore, the personal computer displays the generated three-dimensional image on a display.

As described in US Patent Publication No. 2015/0071528 A1 (PTL 2), there has also been known a technique of classifying land segments and the like from a remotely-sensed earth image (satellite image) by using a device subjected to machine learning.

### CITATION LIST

### Patent Literature

PTL 1: Japanese Patent Laying-Open No. 7-230597
PTL 2: US Patent Publication No. 2015/0071528 A1

### SUMMARY OF INVENTION

### Technical Problem

There has also been a demand to grasp not only a position of a work machine at a work site but also a work type of a work performed at the work site, at a location that is distant from the work site.

The present disclosure provides an information processing device, an information processing method, a trained model generation method, a system, and a learning data set, all of which make it possible to estimate a work type of a work performed at a work site.

### Solution to Problem

According to the present disclosure, an information processing device includes: a computing device; a storage device having a trained model stored therein, the trained model being configured to estimate, from image data, a work type of a work performed at a work site where a work machine is operating, the image data being obtained by capturing an image of the work site from the sky; and an output device. The computing device estimates the work type from the image data input thereto, by using the trained model. The computing device causes the output device to output the estimated work type.

Preferably, the trained model is configured to estimate the work type from the image data and machine information of the work machine. When the computing device receives an input of the image data and an input of the machine information of the work machine, the computing device estimates the work type from the image data and the machine information of the work machine by using the trained model.

Preferably, the machine information includes position information of the work machine.

Preferably, the machine information includes machine type information of the work machine.

Preferably, the machine information includes machine state information during operation of the work machine.

Preferably, the information processing device obtains the machine information from a server.

Preferably, the trained model is generated through learning using a learning data set. The learning data set includes the image data obtained by capturing, from the sky, the image of the work site where the work machine is operating, and teacher data indicating the work type at the work site.

Preferably, the image data is satellite image data obtained by an artificial satellite.

According to another aspect of the present disclosure, an information processing method includes: receiving, by a computing device, an input of image data, the image data being obtained by capturing, from the sky, an image of a work site where a work machine is operating; estimating, by the computing device, a work type of a work performed at the work site from the received image data by using a trained model; and causing, by the computing device, an output device to output the estimated work type.

According to still another aspect of the present disclosure, a trained model generation method includes obtaining a learning data set. The learning data set includes image data obtained by capturing, from the sky, an image of a work site where a work machine is operating, and teacher data indicating a work type of a work performed at the work site. The trained model generation method further includes generating a trained model through a learning process using the learning data set. The trained model is a program for estimating the work type at the work site based on the image data obtained by capturing, from the sky, the image of the work site where the work machine is operating.

According to a further aspect of the present disclosure, a system includes a learning device and a terminal device. The learning device generates a trained model through learning using a learning data set. The learning data set includes image data obtained by capturing, from the sky, an image of a work site where a work machine is operating, and teacher data indicating a work type of a work performed at the work site. The terminal device obtains the trained model from the learning device. By using the trained model, the terminal device estimates the work type at the work site from the image data obtained by capturing, from the sky, the image of the work site where the work machine is operating. The terminal device outputs the estimated work type.

According to a further aspect of the present disclosure, a learning data set is used to generate a trained model for estimating a work type at a work site where a work machine is operating, and the learning data set includes image data obtained by capturing, from the sky, an image of the work site where the work machine is operating, and teacher data indicating a work type of a work performed at the work site.

### Advantageous Effects of Invention

According to the present disclosure, it is possible to estimate the work type of the work performed at the work site.

### BRIEF DESCRIPTION OF DRAWINGS

FIG. 1 shows a schematic configuration of a communication system.

FIG. 2 shows a schematic configuration of a database stored in a server device.

FIG. 3 is a diagram for illustrating an estimation process in a terminal device.

FIG. 4 is a schematic view showing an example hardware configuration of the terminal device.

FIG. 5 is a schematic view showing an example hardware configuration of the server device.

FIG. 6 is a functional block diagram for illustrating a functional configuration of the server device.

FIG. 7 is a block diagram for illustrating details of a process (learning function) in a learning unit.

FIG. 8 is a flowchart showing a process procedure of a learning process in the server device.

FIG. 9 is a functional block diagram for illustrating a functional configuration of the terminal device.

FIG. 10 is a block diagram for illustrating details of a process (estimation function) in a work type estimating unit.

FIG. 11 is a schematic view showing an example of a network structure of a trained model shown in FIG. 10.

FIG. 12 is a flowchart showing a process procedure of the estimation process in the terminal device.

### DESCRIPTION OF EMBODIMENTS

First, a part of the terms used in the present embodiment will be described.

“Learning data set” refers to secondary processed data generated by performing conversion and/or processing on raw data, in order to facilitate analysis using a target learning method. The conversion and/or processing includes preprocessing such as removal of a missing value or an outlier, addition of another data such as label information (correct answer data), or a combination thereof “Raw data” refers to data obtained primarily by a user, a vendor, or any other business operator or research institute, and converted and/or processed so as to be read into a database.

“Learning program” refers to a program that performs an algorithm for finding a certain rule from a learning data set and generating a model that expresses the rule. Specifically, a program that defines a procedure to be performed by a computer in order to implement learning using an adopted learning method corresponds to “learning program”.

“Trained model” refers to “inference program” into which “trained parameter” is incorporated. “Trained parameter” refers to a parameter (coefficient) obtained as a result of learning using a learning data set. The trained parameter is generated by inputting a learning data set into a learning program and making mechanical adjustment for a certain purpose. “Inference program” refers to a program that allows a certain result to be output for an input by applying an incorporated trained parameter.

<A. Overview>

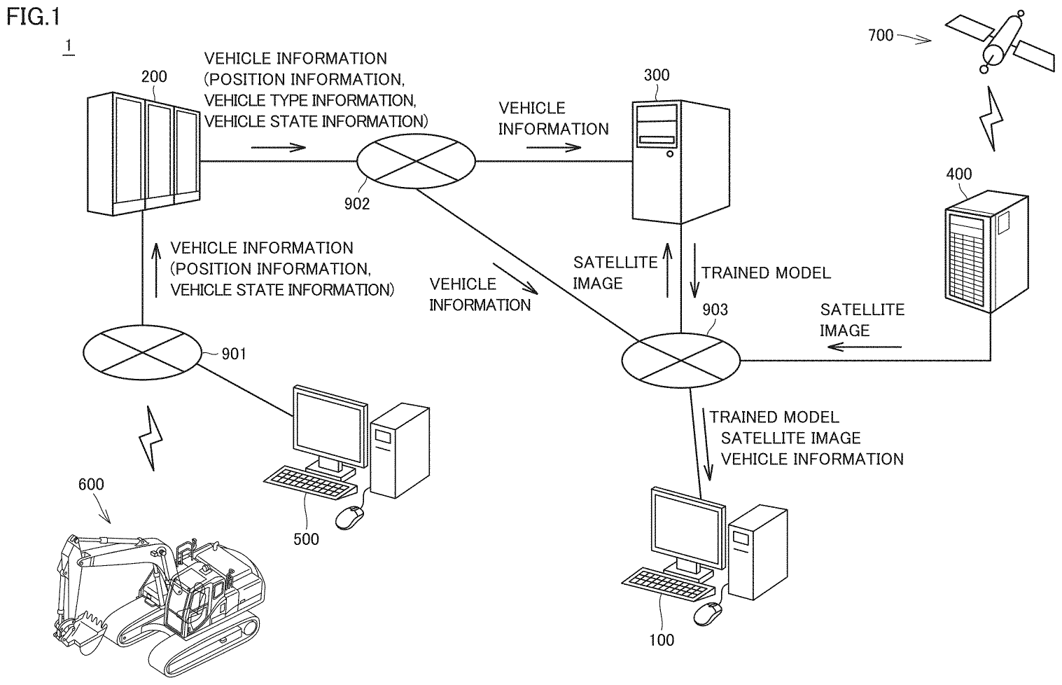

FIG. 1 shows a schematic configuration of a communication system 1 according to the present embodiment.

As shown in FIG. 1, communication system 1 includes a terminal device 100, a server device 200, a server device 300, a server device 400, and a terminal device 500. Communication system 1 performs communication between a work vehicle 600 and an artificial satellite 700. The communication with artificial satellite 700 may be performed through an external server (not shown).

Although FIG. 1 shows one work vehicle 600, the number of the work vehicles is not limited thereto. Server device 200 can obtain vehicle information from a plurality of work vehicles 600. In a learning stage described below, vehicle information of each of the plurality of work vehicles 600 is used.

Although FIG. 1 shows a hydraulic excavator as an example of work vehicle 600, work vehicle 600 is not limited to the hydraulic excavator. Work vehicle 600 may be another type of work vehicle such as a crawler dozer, a wheel loader, a dump truck, and a motor grader.

Although details will be described below, a trained model is generated by server device 300 in the present example. The generated trained model is used in terminal device 100. Terminal device 100 performs an estimation process (a classification process and an identification process) using the trained model. However, the present disclosure is not limited thereto, and server device 300 that generates the trained model may perform the estimation process using the trained model.

(Server Device 400)

Server device 400 obtains an image of a work site captured from the sky. In the present example, server device 400 obtains, from artificial satellite 700, an image captured by artificial satellite 700 (hereinafter, also referred to as “satellite image”). The satellite image can be, for example, a captured image of a location of 0.5 km to 20 km square (location including the land, a lake, a pond, the sea or the like).

(Terminal Device 500)

Terminal device 500 is placed in a work vehicle dealer and the like. Information input using terminal device 500 is transmitted to and stored in server device 200. The information input using terminal device 500 will be described below.

(Server Device 200)

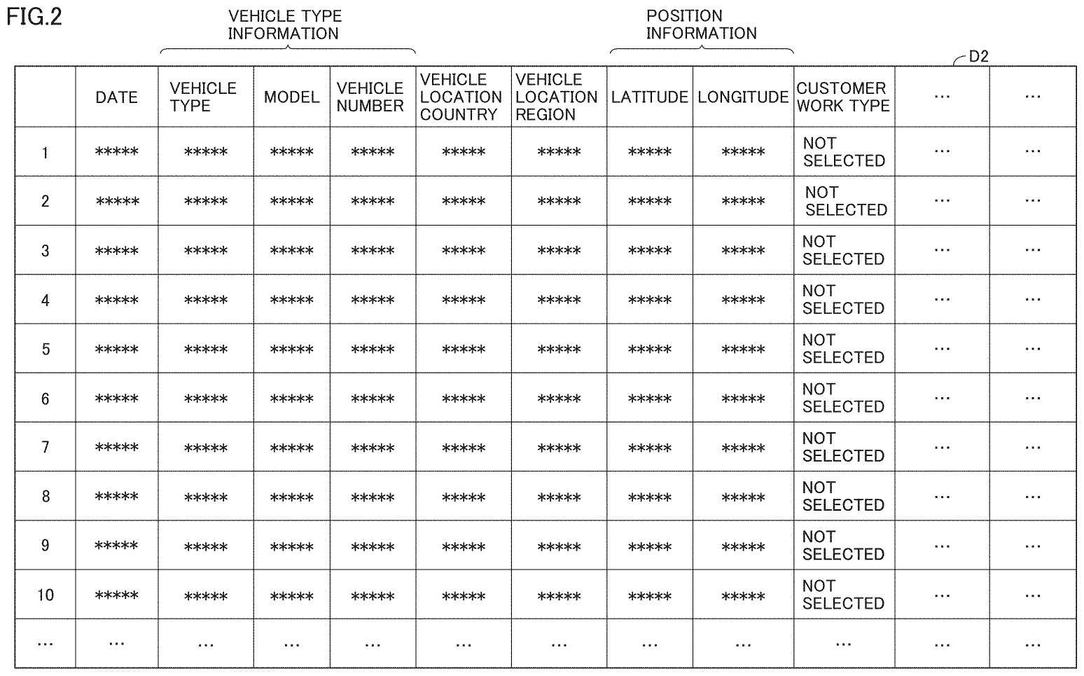

Server device 200 is a device for storing various types of data about each work vehicle 600. The data is stored in a database D2 (see FIG. 2). In addition, the data is sequentially updated by communication with each work vehicle 600, communication with terminal device 500, a user operation on server device 200, and the like. Server device 200 is managed by, for example, a manufacturer of work vehicle 600.

Server device 200 obtains the vehicle information of work vehicle 600 from work vehicle 600 through a network 901 and stores the vehicle information. The vehicle information includes position information indicating a position of work vehicle 600, and vehicle state information indicating a vehicle state of work vehicle 600.

The vehicle state information includes various types of information obtained or calculated by work vehicle 600 during operation of work vehicle 600. For example, the vehicle state information includes information such as a pump pressure, a cylinder pressure, a traveling speed, and a fuel consumption.

Vehicle type information of work vehicle 600 is also prestored in server device 200 as the vehicle information. As described above, server device 200 stores at least the position information, the vehicle type information and the vehicle state information as the vehicle information.

Terminal device 100 or server device 300 in the present example corresponds to an example of “information processing device” in the present disclosure. Server device 200 in the present example corresponds to an example of “server” in the present disclosure. Work vehicle 600 in the present example corresponds to an example of “work machine” in the present disclosure.

In addition, the vehicle information in the present example corresponds to an example of “machine information” in the present disclosure. Furthermore, the position information, the vehicle state information and the vehicle type information in the present example correspond to examples of “position information”, “vehicle state information” and “machine information” in the present disclosure, respectively.

In addition, communication system 1 in the present example corresponds to an example of “system” in the present disclosure. Server device 300 in the present example corresponds to an example of “learning device” in the present disclosure. Terminal device 100 in the present example corresponds to an example of “terminal device” in the present disclosure.

FIG. 2 shows a schematic configuration of database D2 stored in server device 200.

As shown in FIG. 2, database D2 stores various types of data for each work vehicle. Database D2 includes at least a plurality of items such as a registration date, a vehicle type, a model, a vehicle number, a vehicle location country, a vehicle location region, a latitude, a longitude, and a customer work type. Although not shown, database D2 also includes an item of the vehicle state information. The vehicle state information may be stored in a database different from database D2.

In the example of database D2, the vehicle type, the model and the vehicle number form “vehicle type information”. The longitude and the latitude form “position information”. The position information is sequentially provided from the work vehicle to server device 200.

The vehicle location country indicates the name of a country (e.g., Thailand) where the work vehicle is used. The vehicle location region indicates a region (e.g., Bangkok) in the vehicle location country where the work vehicle is used.

The customer work type indicates a work type of a customer who purchased the work vehicle. Specifically, the customer work type indicates a type of a work performed using the work vehicle by the customer who purchased the work vehicle. Examples of the work type include ordinary civil engineering, dismantling, gravel gathering, quarrying, steel industry, agriculture, forestry, industrial waste business, sandpit and the like. Depending on work types, different work vehicles are used. The following is one example.

For “ordinary civil engineering” and “quarrying”, hydraulic excavators, crawler dozers, wheel loaders, dump trucks, and motor graders are typically used. For “dismantling” and “sandpit”, hydraulic excavators are used. For “gravel gathering”, hydraulic excavators, crawler dozers, wheel loaders, and motor graders are used. For “steel industry” and “industrial waste business”, hydraulic excavators, crawler dozers, wheel loaders, and dump trucks are used. For “agriculture” and “forestry”, hydraulic excavators, crawler dozers and wheel loaders are used.

Normally, the dealer who sold the work vehicle inputs each item (except for the position information) of database D2, using terminal device 500 (see FIG. 1). However, of these items, data of the customer work type is not entered (the work type is not selected) frequently. If the manufacturer of the work vehicle can know the customer work type, the manufacturer of the work vehicle can provide useful information about maintenance of the work vehicle to a user of the work vehicle and the dealer of the work vehicle.

From the above-described viewpoint, in communication system 1, a work type of a work performed at a work site (work type of a work performed at a work site by a work vehicle) is estimated using machine learning. Then, an estimation result is used as the customer work type.

(Server Device 300)

Returning to FIG. 1, server device 300 obtains the vehicle information from server device 200 through a network 902. In addition, server device 300 obtains the satellite image from server device 400 through a network 903.

Through a learning process using the satellite image of the work site, the vehicle information of the vehicle operating at the work site, and teacher data (correct answer data) indicating the work type, server device 300 generates a trained model for estimating (classifying and identifying) the work type at the work site. The generated trained model is transmitted (distributed) to terminal device 100. Details of a process of generating the trained model (learning process) will be described below.

(Terminal Device 100)

Terminal device 100 obtains the trained model from server device 300 through network 903. Terminal device 100 performs an estimation process described below, using the trained model.

After terminal device 100 obtains the trained model from server device 300, terminal device 100 obtains the vehicle information from server device 200 through network 902. In addition, terminal device 100 obtains the satellite image from server device 400 through network 903. When a user of terminal device 100 performs a predetermined user operation on terminal device 100, terminal device 100 performs obtainment of the vehicle information and obtainment of the satellite image.

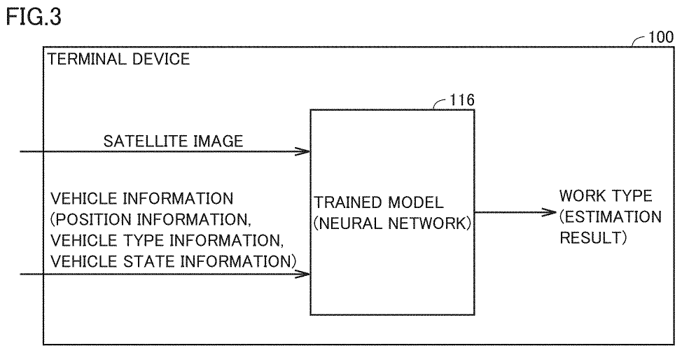

FIG. 3 is a diagram for illustrating the estimation process in terminal device 100.

As shown in FIG. 3, terminal device 100 has a trained model 116. Using trained model 116, terminal device 100 estimates (classifies and identifies) the work type at the work site from the satellite image of the work site and the vehicle information of the vehicle operating at the work site.

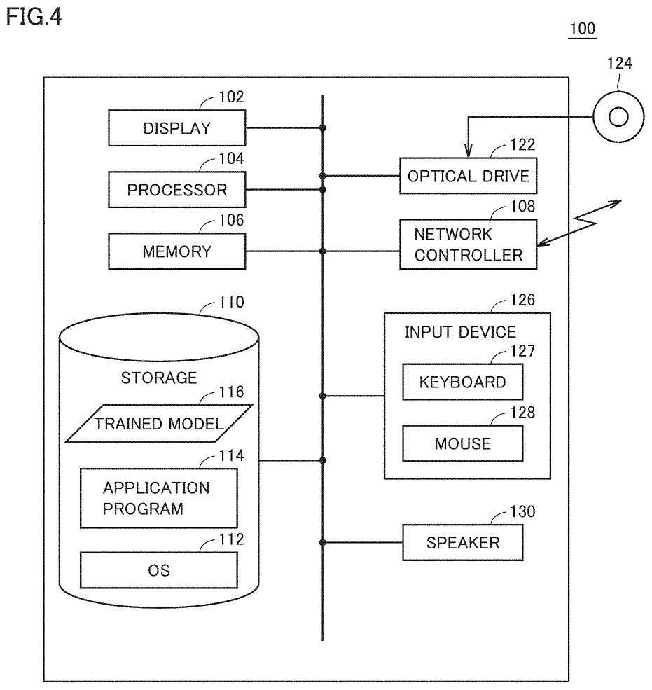

A computing device (typically, a processor 104 (see FIG. 4)) of terminal device 100 inputs the satellite image and the vehicle information into trained model 116. When trained model 116 receives the inputs of the satellite image and the vehicle information, trained model 116 outputs the work type as the estimation result. The computing device outputs the estimation result output from trained model 116 to a display of terminal device 100.

Terminal device 100 may output the estimation result by voice from a speaker of terminal device 100. Furthermore, terminal device 100 may transmit the estimation result to another external device such as server device 200. A form of outputting the estimation result is not particularly limited, and any form may be used as long as the estimation result can be identified.

As described above, the work type of the work performed at the work site is estimated using trained model 116, and thus, the work type of the work performed at the work site can be grasped at a location that is distant from the work site. In addition, useful information about maintenance of the work vehicle operating at the work site can be provided to the user of the work vehicle and the dealer of the work vehicle.

Furthermore, the customer work type in server device 200 can also be updated using the estimation result. The update may be performed by user's manual input of the estimation result. Alternatively, the estimation result may be transmitted from terminal device 100 to server device 200 and automatically updated in server device 200.

<B. Hardware Configuration>

(Terminal Device 100)

FIG. 4 is a schematic view showing an example hardware configuration of terminal device 100.

As shown in FIG. 4, terminal device 100 includes, as main hardware components, a display 102, processor 104, a memory 106, a network controller 108, a storage 110, an optical drive 122, and an input device 126. Input device 126 includes a keyboard 127 and a mouse 128. Input device 126 may include a touch panel.

Display 102 displays information required for processing in terminal device 100. Display 102 is implemented by, for example, a liquid crystal display (LCD), an organic electroluminescence (EL) display or the like.

Processor 104 is a main component for computation that performs a process required to implement terminal device 100 by performing various programs described below. Processor 104 is implemented by, for example, one or more central processing units (CPUs), graphics processing units (GPUs) or the like. A CPU or GPU having a plurality of cores may be used.

Memory 106 provides a storage region that temporarily stores a program code, a work memory and the like when processor 104 performs a program. A volatile memory device such as a dynamic random access memory (DRAM) or a static random access memory (SRAM) may, for example, be used as memory 106.

Network controller 108 receives and transmits data from and to arbitrary devices including server devices 200, 300 and 400 through networks 902 and 903. Network controller 108 may be adapted to an arbitrary communication method such as, for example, Ethernet (registered trademark), wireless LAN (Local Area Network) or Bluetooth (registered trademark).

Storage 110 stores an operating system (OS) 112 performed by processor 104, an application program 114 for implementing a functional configuration described below, trained model 116 and the like. A non-volatile memory device such as, for example, a hard disk and a solid state drive (SSD) may be used as storage 110.

A part of a library or a functional module required when application program 114 is performed in processor 104 may be substituted by a library or a functional module provided as standard by OS 112. In this case, although application program 114 alone does not include all program modules required to implement corresponding functions, the functional configuration described below can be implemented by being installed under the execution environment of OS 112. Therefore, even a program that does not include a part of a library or a functional module can be included in the technical scope of the present disclosure.

Optical drive 122 reads information such as a program stored in an optical disk 124 such as a compact disc read only memory (CD-ROM) or a digital versatile disc (DVD). Optical disk 124 is an example of a non-transitory recording medium and distributes an arbitrary program in a state of being stored in a non-volatile manner. Optical drive 122 reads the program from optical disk 124 and installs the program into storage 110, such that terminal device 100 according to the present embodiment can be implemented. Therefore, the subject matter of the present disclosure can also be directed to a program itself installed into storage 110 or the like, or a recording medium such as optical disk 124 that stores a program for implementing functions or processes according to the present embodiment.

Although FIG. 4 shows an optical recording medium such as optical disk 124 as an example of the non-transitory recording medium, the present disclosure is not limited thereto. A semiconductor recording medium such as a flash memory, a magnetic recording medium such as a hard disk or a storage tape, or a magneto-optical recording medium such as a magneto-optical disk (MO) may be used.

Alternatively, the program for implementing terminal device 100 may not only be distributed in a state of being stored in an arbitrary recording medium as described above, but also be distributed by being downloaded from the server devices and the like through the Internet or Intranet.

Although FIG. 4 shows a configuration example in which a general-purpose computer (processor 104) performs application program 114 to thereby implement terminal device 100, all or a part of the functions required to implement terminal device 100 may be implemented using a hard-wired circuit such as an integrated circuit. For example, all or a part of the functions may be implemented using an application specific integrated circuit (ASIC), a field-programmable gate array (FPGA) or the like.

Processor 104 corresponds to an example of “computing device” in the present disclosure. Storage 110 corresponds to an example of “storage device” in the present disclosure. Display 102 corresponds to an example of “output device” in the present disclosure.

(Server Device 300)

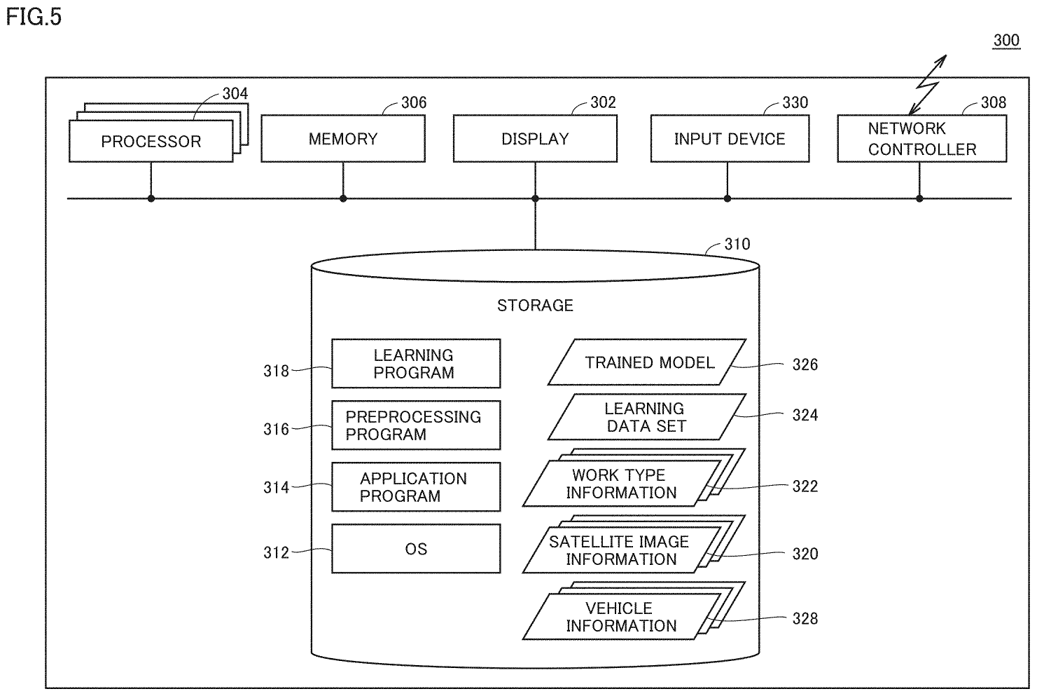

FIG. 5 is a schematic view showing an example hardware configuration of server device 300.

As shown in FIG. 5, server device 300 includes, as main hardware components, a display 302, a processor 304, a memory 306, a network controller 308, a storage 310, and an input device 330.

Display 302 displays information required for processing in server device 300. Display 302 is implemented by, for example, an LCD, an organic EL display or the like.

Processor 304 is a main component for computation that performs a process required to implement server device 300 by performing various programs described below. Processor 304 is implemented by, for example, one or more CPUs or GPUs. A CPU or GPU having a plurality of cores may be used. In server device 300, a GPU or the like suitable for the learning process for generating the trained model is preferably used.

Memory 306 provides a storage region that temporarily stores a program code, a work memory and the like when processor 304 performs a program. A volatile memory device such as DRAM or SRAM may, for example, be used as memory 306.

Network controller 308 receives and transmits data from and to arbitrary devices including server devices 200 and 400 and terminal device 100 through networks 902 and 903. Network controller 308 may be adapted to an arbitrary communication method such as, for example, Ethernet, wireless LAN or Bluetooth.

Storage 310 stores an OS 312 performed in processor 304, an application program 314 for implementing a functional configuration described below, a preprocessing program 316 for generating a learning data set 324 based on a satellite image 320, vehicle information 328 and work type information 322, a learning program 318 for generating a trained model 326 using learning data set 324, and the like. A process of obtaining work type information 322 will be described in detail below.

For convenience of description, the different reference characters (116 and 326) are assigned to the trained model stored in terminal device 100 and the trained model generated by server device 300. However, trained model 116 stored in terminal device 100 is a trained model transmitted (distributed) from server device 300, and thus, two trained models 116 and 326 are substantially the same. Specifically, trained model 116 and trained model 326 are substantially the same in terms of a network structure and a trained parameter.

Learning data set 324 is a training data set in which satellite image 320 and vehicle information 328 are labeled (or tagged) with work type information 322. Trained model 326 is an estimation model obtained by performing the learning process using learning data set 324.

A non-volatile memory device such as, for example, a hard disk or an SSD may be used as storage 310.

A part of a library or a functional module required when application program 314, preprocessing program 316 and learning program 318 are performed in processor 304 may be substituted by a library or a functional module provided as standard by OS 312. In this case, although each of application program 314, preprocessing program 316 and learning program 318 alone does not include all program modules required to implement corresponding functions, the functional configuration described below can be implemented by being installed under the execution environment of OS 312. Therefore, even a program that does not include a part of a library or a functional module can be included in the technical scope of the present disclosure.

Application program 314, preprocessing program 316 and learning program 318 may be distributed in a state of being stored in a non-transitory recording medium including an optical recording medium such as an optical disk, a semiconductor recording medium such as a flash memory, a magnetic recording medium such as a hard disk or a storage tape, or a magneto-optical recording medium such as an MO, and installed into storage 310. Therefore, the subject matter of the present disclosure can also be directed to a program itself installed into storage 310 or the like, or a recording medium that stores a program for implementing functions or processes according to the present embodiment.

Alternatively, the program for implementing server device 300 may not only be distributed in a state of being stored in an arbitrary recording medium as described above, but also be distributed by being downloaded from the server devices and the like through the Internet or Intranet.

Input device 330 receives various input operations. A keyboard, a mouse, a touch panel and the like may, for example, be used as input device 330.

Although FIG. 5 shows a configuration example in which a general-purpose computer (processor 304) performs application program 314, preprocessing program 316 and learning program 318 to thereby implement server device 300, all or a part of the functions required to implement server device 300 may be implemented using a hard-wired circuit such as an integrated circuit. For example, all or a part of the functions may be implemented using an ASIC, an FPGA or the like.

Processor 304 corresponds to an example of “computing device” in the present disclosure. Storage 310 corresponds to an example of “storage device” in the present disclosure. Display 302 corresponds to an example of “output device” in the present disclosure.

<C. Learning Stage>

The learning process performed by server device 300 will be described. Specifically, a method for generating trained model 326 will be described.

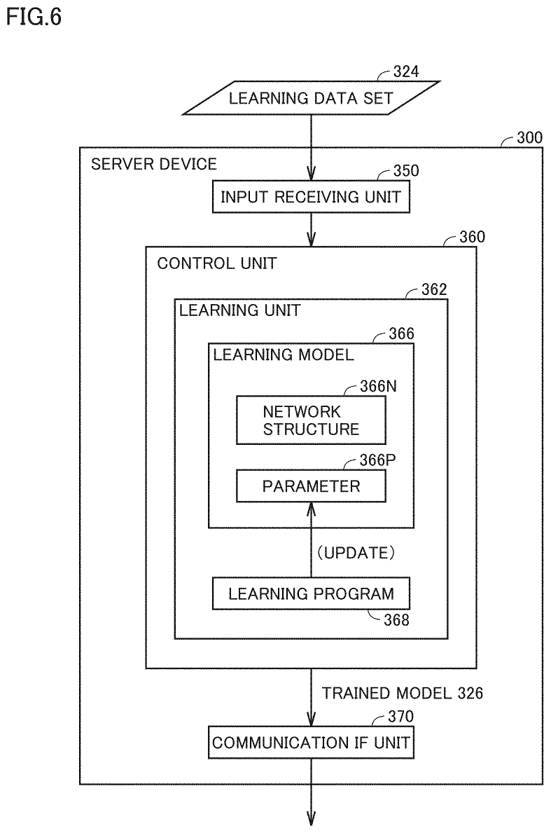

FIG. 6 is a functional block diagram for illustrating a functional configuration of server device 300.

As shown in FIG. 6, server device 300 includes an input receiving unit 350, a control unit 360 and a communication interface (IF) unit 370. Control unit 360 includes a learning unit 362. Learning unit 362 includes a learning model 366 and a learning program 368. Learning model 366 is formed of a network structure 366N and a parameter 366P. Network structure 366N is preliminarily constructed and stored in server device 300.

Input receiving unit 350 receives an input of learning data set 324. Learning data set 324 includes a satellite image for learning, vehicle information for learning, and work type information serving as teacher data. Specifically, learning data set 324 includes a plurality of sets of data (learning data) and each set (each piece of learning data) includes a satellite image, vehicle information for learning, and work type information serving as teacher data. A part of the plurality of sets of data in the learning data set may be used to evaluate the accuracy of the trained model.

The teacher data can be obtained using the following method.

For example, when data of the customer work type is input into database D2, the data can be used as the teacher data. In this case, a satellite image of a work site including a work vehicle, vehicle information of the work vehicle, and a customer work type (teacher data) of the work vehicle correspond to one set of data that forms the learning data set.

In some cases, although data of the customer work type is not input into database D2, the dealer may have the data of the customer work type. For example, the data of the customer work type may in some cases be stored in a recording medium including a sheet of paper. In such a case, the data owned by the dealer can be used as the teacher data.

Furthermore, an employee of the manufacturer or the like may go to a work site and check a work type of a work performed at the work site. In this case, the checked work type can be used as the teacher data. In this case, a satellite image of the work site including a work vehicle, vehicle information of the work vehicle, and the work type (teacher data) of the work checked at the work site correspond to one set of data that forms the learning data set.

Control unit 360 controls an overall operation of server device 300.

Learning unit 362 in control unit 360 generates trained model 326. The generation of trained model 326 will be described below.

Learning unit 362 updates a value of parameter 366P of learning model 366 through machine learning using learning data set 324. Specifically, learning unit 362 updates a value of parameter 366P by using learning program 368. The update of parameter 366P is repeated by the number of the sets of data used for learning (except for the sets of data used for evaluation).

When learning ends, trained model 326 is obtained. Trained model 326 includes network structure 366N and a trained parameter. Updated parameter 366P corresponds to the trained parameter.

Generated trained model 326 is transmitted to terminal device 100 through communication IF 370. As described above, for convenience of description, trained model 326 transmitted to terminal device 100 is referred to as “trained model 116”.

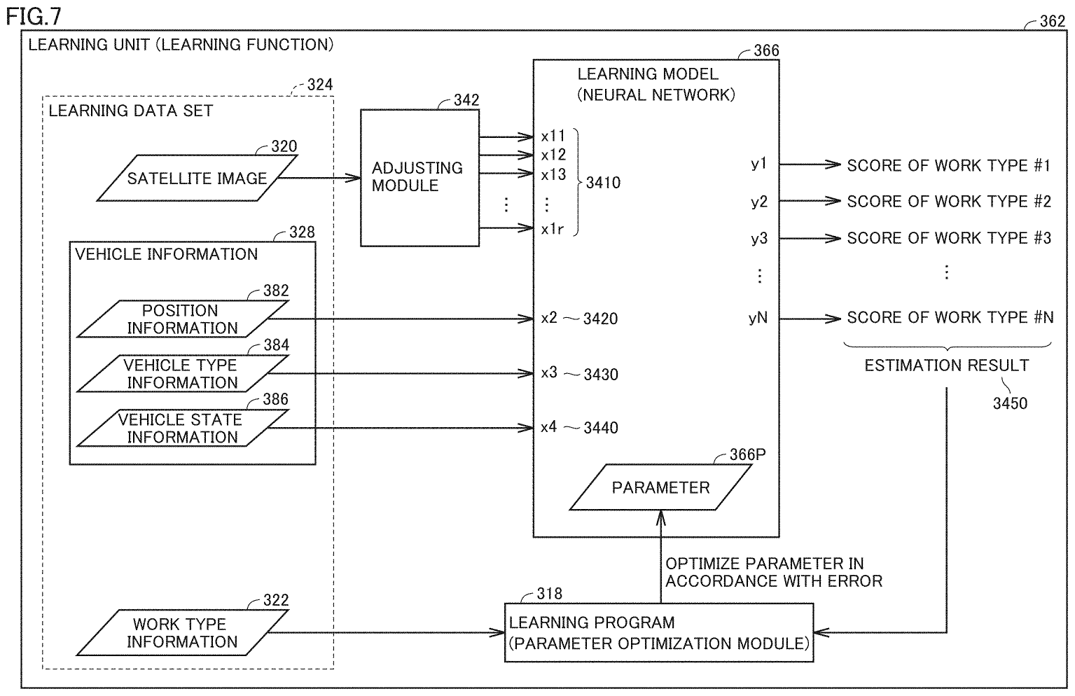

FIG. 7 is a block diagram for illustrating details of a process (learning function) in learning unit 362.

As shown in FIG. 7, learning unit 362 includes an adjusting module 342.

In adjusting module 342, satellite image 320 is converted into a feature amount (feature amount vector) having a predetermined dimension, which is provided to learning model 366. Since an image size of satellite image 320 may vary, adjusting module 342 standardizes the image size.

More specifically, adjusting module 342 adjusts the satellite image to an image having the predetermined number of pixels, and inputs a pixel value of each pixel that forms the adjusted image to learning model 366 as a feature amount 3410.

In addition, vehicle information 328 in the same set as that of the satellite image is provided to learning model 366 as a feature amount. Specifically, position information 382 is provided to learning model 366 as a feature amount 3420. Vehicle type information 384 is provided to learning model 366 as a feature amount 3430. Vehicle state information 386 is provided to learning model 366 as a feature amount 3440.

As described above, learning unit 362 includes learning program 318. Learning program 318 is a parameter optimization module. Learning program 318 optimizes parameter 366P for defining learning model 366, to thereby generate trained model 326 (see FIGS. 5 and 6).

Learning program 318 optimizes parameter 366P by using each set of satellite image 320, vehicle information 328 and work type information 322 (each piece of learning data) included in learning data set 324.

Learning unit 362 generates feature amount 3410 from satellite image 320 included in learning data set 324, and inputs feature amount 3410 to learning model 366, to thereby calculate an estimation result 3450. Specifically, in learning unit 362, a score for each work type is calculated as estimation result 3450.

Learning program 318 compares estimation result 3450 output from learning model 366 with corresponding work type information 322 (teacher data, correct answer data, correct answer label) to thereby calculate an error, and optimizes (adjusts) the value of parameter 366P in accordance with the calculated error.

As described above, learning program 318 optimizes learning model 366 such that estimation result 3450, which is output by inputting feature amounts 3410, 3420, 3430, and 3440 extracted from the learning data (satellite image 320 and vehicle information 328 labeled with work type information 322) to learning model 366, comes close to work type information 322 with which the learning data is labeled. Specifically, learning program 318 adjusts parameter 366P such that estimation result 3450, which is calculated when feature amount 3410 and feature amounts 3420, 3430 and 3440 about vehicle information 328 are input to learning model 366, matches with corresponding work type information 322.

Using a similar procedure, parameter 366P of learning model 366 is repeatedly optimized based on the pieces of learning data (satellite image 320, position information 382, vehicle type information 384, vehicle state information 386, and work type information 322) included in learning data set 324, to thereby generate trained model 326.

When learning program 318 optimizes the value of parameter 366P, an arbitrary optimization algorithm can be used. More specifically, a gradient method such as, for example, stochastic gradient descent (SGD), momentum SGD, AdaGrad, RMSprop, AdaDelta, or adaptive moment estimation (Adam) can be used as the optimization algorithm.

Learning model 366 in which parameter 366P has been optimized by learning program 318 corresponds to trained model 326, and is transmitted to terminal device 100 as described above.

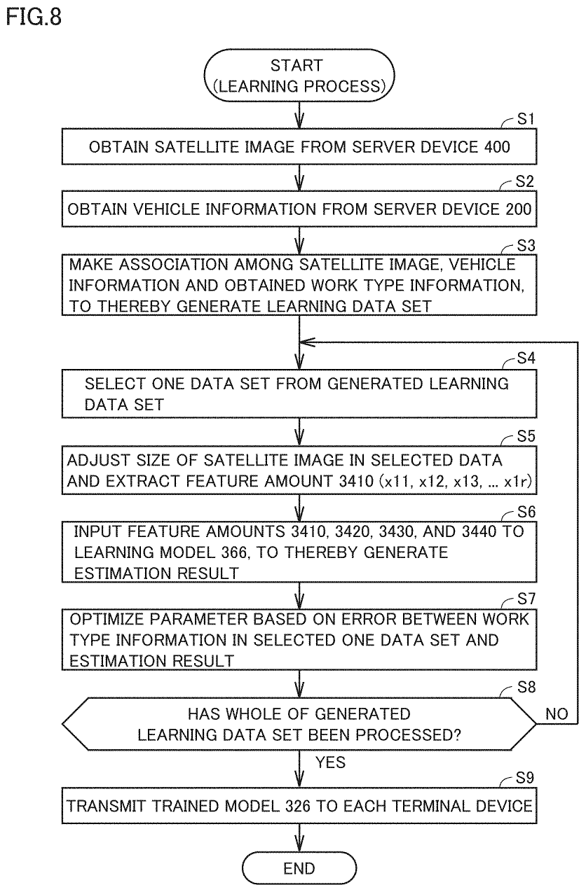

FIG. 8 is a flowchart showing a process procedure of the learning process in server device 300.

Each step shown in FIG. 8 may be typically implemented by processor 304 of server device 300 performing OS 312, application program 314, preprocessing program 316, and learning program 318 (all of which are shown in FIG. 5).

As shown in FIG. 8, server device 300 obtains satellite image 320 from server device 400 (step S1). In addition, server device 300 obtains vehicle information 328 from server device 200 (step S2). Next, server device 300 makes an association among satellite image 320, vehicle information 328 and work type information 322, to thereby generate learning data set 324 (step S3).

Server device 300 selects one data set (learning data) from generated learning data set 324 (step S4). Server device 300 adjusts a size of satellite image 320 and extracts feature amount 3410 (step S5).

Server device 300 inputs feature amount 3410 generated in step S5 and feature amounts 3420, 3430 and 3440 about vehicle information 328 to learning model 366, to thereby generate estimation result 3450 (step S6). Next, server device 300 optimizes parameter 366P of learning model 366 based on an error between work type information 322 in the selected data and estimation result 3450 generated in step S6 (step S7).

As described above, server device 300 performs a process of optimizing parameter 366P of learning model 366 such that estimation result 3450, which is output by inputting feature amount 3410, feature amount 3420, feature amount 3430, and feature amount 3440 to learning model 366, comes close to the work type (work type information 322) with which the learning data is labeled.

Server device 300 determines whether or not the whole of learning data set 324 generated in step S3 has been processed (step S8). When the whole of learning data set 324 has not been processed (NO in step S8), the processing in step S4 and the subsequent steps is repeated. When the whole of learning data set 324 has been processed (YES in step S8), server device 300 transmits trained model 326 defined by current parameter 366P to terminal device 100 (step S9). The learning process is thus completed.

As described above, in terminal device 100, the trained model transmitted from server device 300 is denoted by the reference character “116”.

<D. Use Stage>

The use of trained model 116 transmitted (distributed) from server device 300 will be described. Specifically, the estimation process performed by terminal device 100 will be described.

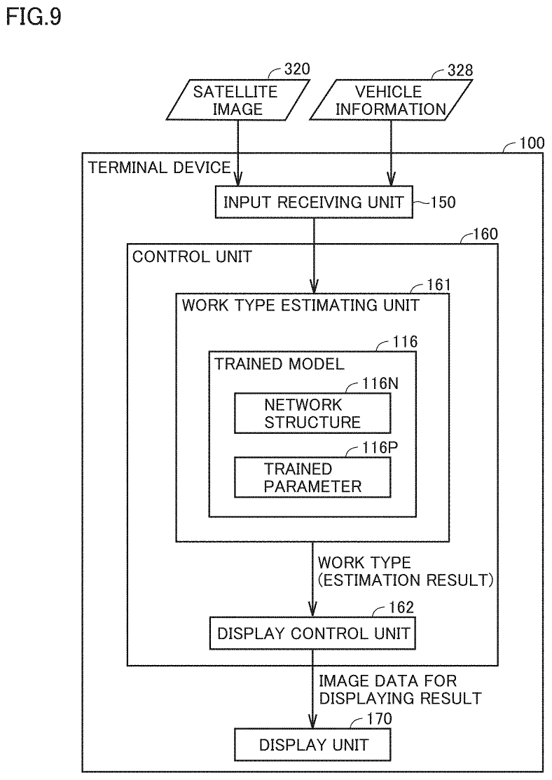

FIG. 9 is a functional block diagram for illustrating a functional configuration of terminal device 100.

As shown in FIG. 9, terminal device 100 includes an input receiving unit 150, a control unit 160 and a display unit 170. Control unit 160 includes a work type estimating unit 161 and a display control unit 162. Work type estimating unit 161 includes trained model 116.

Input receiving unit 150 receives an input of satellite image 320 and an input of vehicle information 328.

Control unit 160 controls an overall operation of terminal device 100.

Work type estimating unit 161 in control unit 160 includes trained model 116. Trained model 116 is formed of a network structure 116N and a trained parameter 116P. Network structure 116N is substantially the same as network structure 366N (see FIG. 6).

Using trained model 116, work type estimating unit 161 estimates the work type of the work performed at the work site, from satellite image 320 and vehicle information 328. Work type estimating unit 161 transmits the work type information, which is an estimation result, to display control unit 162.

Display control unit 162 causes display unit 170 to display the work type information. Display unit 170 corresponds to display 102 (see FIG. 4).

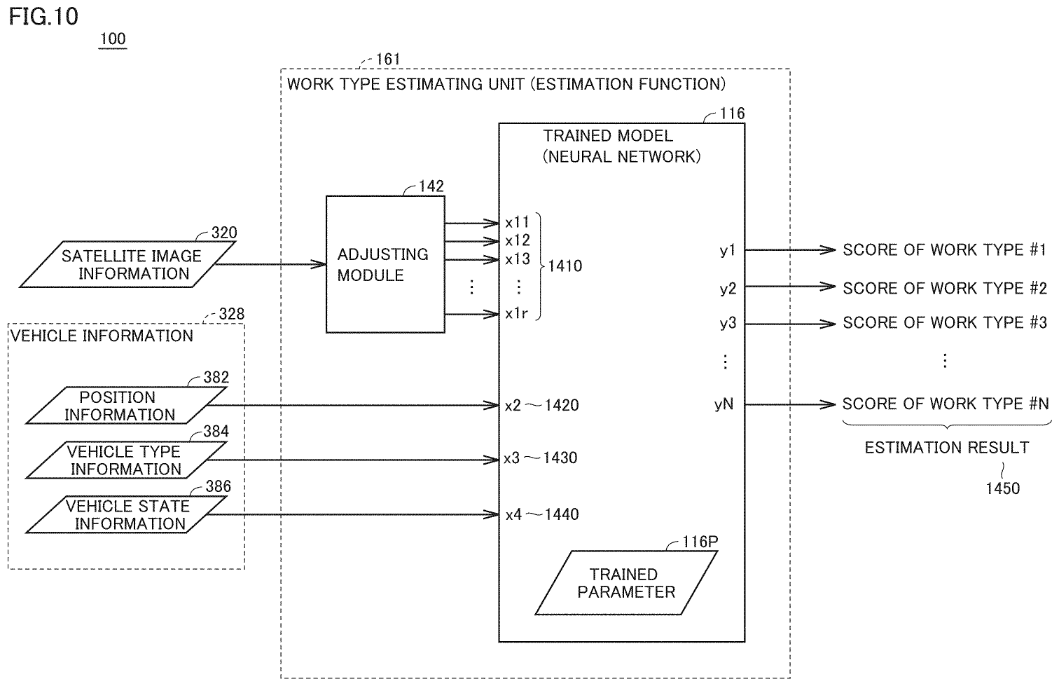

FIG. 10 is a block diagram for illustrating details of a process (estimation function) in work type estimating unit 161.

As shown in FIG. 10, work type estimating unit 161 includes an adjusting module 142 and trained model 116. Adjusting module 142 is substantially the same as adjusting module 342 (see FIG. 7) of server device 300.

In adjusting module 142, satellite image 320 is converted into a feature amount (feature amount vector) having a predetermined dimension, and is provided to trained model 116. Since an image size of satellite image 320 may vary, adjusting module 142 standardizes the image size.

More specifically, adjusting module 142 adjusts the satellite image to an image having the predetermined number of pixels, and inputs a pixel value of each pixel that forms the adjusted image to trained model 116 as a feature amount 1410.

In addition, vehicle information 328 in the same set as that of the satellite image is provided to trained model 116 as a feature amount. Specifically, position information 382 is provided to trained model 116 as a feature amount 1420. Vehicle type information 384 is provided to trained model 116 as a feature amount 1430. Vehicle state information 386 is provided to trained model 116 as a feature amount 1440.

As described above, trained model 116 is formed of network structure 116N and trained parameter 116P. When feature amounts 1410, 1420, 1430, and 1440 are input to trained model 116, a computation process defined by trained model 116 is performed and a score for each work type is calculated as an estimation result 1450. The score for each work type herein refers to a value indicating the possibility that each work type is a work type to be estimated. The higher a score of a work type is, the higher the possibility that the work type is a work type of a work performed at a work site is. It is preferable that the score is normalized.

Control unit 160 (FIG. 7) causes display unit 170 to display the work type having the highest score. However, the present disclosure is not limited thereto, and control unit 160 may output the estimation result as the score of each work type.

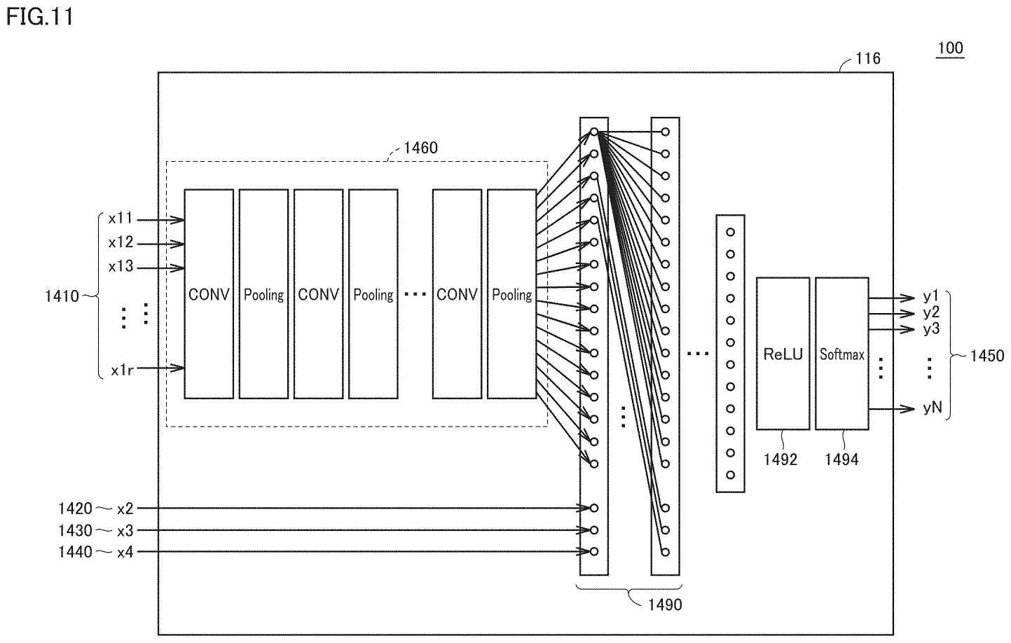

FIG. 11 is a schematic view showing an example of network structure 116N of trained model 116 shown in FIG. 10.

As shown in FIG. 11, trained model 116 is a network classified as a deep neural network (DNN). Trained model 116 includes a preprocessing network 1460 classified as a convolutional neural network (CNN), an intermediate layer 1490, an activation function 1492 corresponding to an output layer, and a Softmax function 1494.

Preprocessing network 1460 is expected to function as one type of filter for extracting a feature amount effective for calculating estimation result 1450 from feature amount 1410 having a relatively large order. Preprocessing network 1460 has a configuration in which convolution layers (CONVs) and pooling layers (Poolings) are alternately arranged. The number of convolution layers and the number of pooling layers may not be the same, and the activation function such as a rectified linear unit (ReLU) is arranged on the output side of the convolution layers.

More specifically, preprocessing network 1460 is constructed to receive an input of feature amount 1410 (x11, x12, . . . , x1r), and output an internal feature amount indicating prescribed attribute information.

Intermediate layer 1490 is formed of a fully connected network having the prescribed number of layers, and sequentially connects outputs from preprocessing network 1460 for each node by using a weight and a bias determined for each node.

Activation function 1492 such as the ReLU is arranged on the output side of intermediate layer 1490, and the outputs are finally normalized to probability distribution by Softmax function 1494 and estimation result 1450 (y1, y2, . . . , yN) is output.

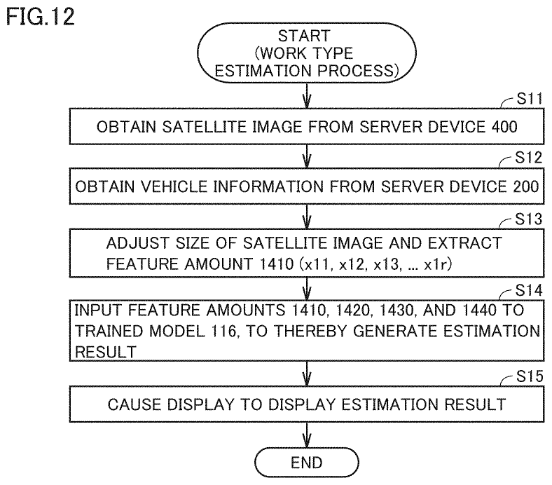

FIG. 12 is a flowchart showing a process procedure of the estimation process in terminal device 100.

Each step shown in FIG. 12 may be typically implemented by processor 104 of terminal device 100 performing OS 112 and application program 114 (both of which are shown in FIG. 4).

As shown in FIG. 12, terminal device 100 obtains satellite image 320 from server device 400 (step S11). Terminal device 100 obtains vehicle information 328 from server device 200 (step S12). Terminal device 100 adjusts a size of satellite image 320 and extracts feature amount 3410 (step S13).

Terminal device 100 inputs the feature amount of satellite image 320 and the feature amount of the vehicle information to trained model 116, to thereby generate the estimation result (step S14). Using trained model 116, terminal device 100 estimates the work type from the feature amount of satellite image 320 and the feature amount of the vehicle information.

Terminal device 100 causes display 102 to display the estimation result (step S15). Specifically, terminal device 100 generates image data indicating the work type having the highest score of the estimation result, and causes display 102 to display the generated image data (data for displaying the work type).

<E. Modification>

(1) In the above-described embodiment, server device 300 generates trained model 326 through the learning process using satellite image 320 and vehicle information 328, in order to estimate the work type with high accuracy. In addition, terminal device 100 performs the process of estimating the work type by using trained model 116 (trained model 116 that is substantially the same as trained model 326) obtained from server device 300. However, the learning using vehicle information 328 and the use of vehicle information 328 are not essential.

For example, server device 300 may generate a trained model through a learning process using only satellite image 320, and terminal device 100 may perform the process of estimating the work type by using the trained model obtained from server device 300.

(2) When the trained model is generated by using vehicle information 328, the trained model is generated through the learning process using the three pieces of information (position information 382, vehicle type information 384 and vehicle state information 386) as vehicle information 328. However, the present disclosure is not limited thereto. When the trained model is generated by using vehicle information 328, server device 300 may generate the trained model by using at least one or more of position information 382, vehicle type information 384 and vehicle state information 386.

In addition, when the trained model is generated by using vehicle information 328, the work type can be estimated with higher accuracy, as more of the three types of information, i.e., position information 382, vehicle type information 384 and vehicle state information 386, is used to generate the trained model.

(3) In the above-described embodiment, the image (satellite image) captured by artificial satellite 700 is taken as an example of “image data obtained by capturing, from the sky, an image of a work site where a work machine is operating”. However, the present disclosure is not limited thereto, and an image captured by an aircraft (equipment flying in the air) such as, for example, an unmanned aerial vehicle (UAV), an airplane or a helicopter may be used instated of the satellite image.

The embodiment disclosed herein is presented by way of example, and is not limited to the specific details described above. The scope of the present disclosure is defined by the terms of the claims and is intended to include any modifications within the scope and meaning equivalent to the terms of the claims.

### REFERENCE SIGNS LIST

1 communication system; 100, 500 terminal device; 102, 302 display; 104, 304 processor; 106, 306 memory; 110, 310 storage; 114, 314 application program; 116, 326 trained model; 116N, 366N network structure; 116P trained parameter; 142, 342 adjusting module; 150, 350 input receiving unit; 160, 360 control unit; 161 work type estimating unit; 162 display control unit; 170 display unit; 200, 300, 400 server device; 316 preprocessing program; 318, 368 learning program; 320 satellite image; 322 work type information; 324 learning data set; 328 vehicle information; 362 learning unit; 366 learning model; 366P parameter; 382 position information; 384 vehicle type information; 386 vehicle state information; 600 work vehicle; 700 artificial satellite; 901, 902, 903 network; 1410, 1420, 1430, 1440, 3410, 3420, 3430, 3440 feature amount; 1450, 3450 estimation result; 1460 preprocessing network; 1490 intermediate layer; 1492 activation function; 1494 Softmax function; D2 database.

1. An information processing device comprising:
a computing device;
a storage device having a trained model stored therein, the trained model being configured to estimate, from image data, a work type of a work performed at a work site where a work machine is operating, the image data being obtained by capturing an image of the work site from the sky; and
an output device, wherein
the computing device
estimates the work type from the image data input thereto, by using the trained model, and
causes the output device to output the estimated work type.

2. The information processing device according to claim 1, wherein
the trained model is configured to estimate the work type from the image data and machine information of the work machine, and
when the computing device receives an input of the image data and an input of the machine information of the work machine, the computing device estimates the work type from the image data and the machine information of the work machine by using the trained model.

3. The information processing device according to claim 2, wherein
the machine information includes position information of the work machine.

4. The information processing device according to claim 2, wherein
the machine information includes machine type information of the work machine.

5. The information processing device according to claim 2, wherein
the machine information includes machine state information during operation of the work machine.

6. The information processing device according to claim 2, wherein
the information processing device obtains the machine information from a server.

7. The information processing device according to claim 1, wherein
the trained model is generated through learning using a learning data set, and
the learning data set includes the image data obtained by capturing, from the sky, the image of the work site where the work machine is operating, and teacher data indicating the work type at the work site.

8. The information processing device according to claim 1, wherein
the image data is satellite image data obtained by an artificial satellite.

9. An information processing method comprising:
receiving, by a computing device, an input of image data, the image data being obtained by capturing, from the sky, an image of a work site where a work machine is operating;
estimating, by the computing device, a work type of a work performed at the work site from the received image data by using a trained model; and
causing, by the computing device, an output device to output the estimated work type.

10. A trained model generation method comprising:
obtaining a learning data set, the learning data set including image data obtained by capturing, from the sky, an image of a work site where a work machine is operating, and teacher data indicating a work type of a work performed at the work site; and
generating a trained model through a learning process using the learning data set, the trained model being a program for estimating the work type at the work site based on the image data obtained by capturing, from the sky, the image of the work site where the work machine is operating.

11. A system comprising a learning device and a terminal device, wherein
the learning device generates a trained model through learning using a learning data set, the learning data set including image data obtained by capturing, from the sky, an image of a work site where a work machine is operating, and teacher data indicating a work type of a work performed at the work site, and
the terminal device
obtains the trained model from the learning device,
by using the trained model, estimates the work type at the work site from the image data obtained by capturing, from the sky, the image of the work site where the work machine is operating, and
outputs the estimated work type.

12. A learning data set used to generate a trained model for estimating a work type at a work site where a work machine is operating, the learning data set including image data obtained by capturing, from the sky, an image of the work site where the work machine is operating, and teacher data indicating the work type of a work performed at the work site.
